(19) United States
(12) Patent Application Publication
(10) Pub. No.: US 2008/0026113 A1
(43) Pub. Date: Jan. 31, 2008

(54) PACKAGED TEA BEVERAGE

(75) Inventors: Satoshi HAYASHI, Sumida-ku (JP); Hideyuki Takatsu, Sumida-ku (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kao Corporation, Chuo-ku (JP)

(21) Appl. No.: 11/567,439

(22) Filed: Dec. 6, 2006

(30) Foreign Application Priority Data
Dec. 12, 2005 (JP) 2005-357185

(51) Int. Cl. A23F 3/00; A23F 3/16

(52) U.S. Cl. 426/106

(57) ABSTRACT

A packaged tea beverage contains from 0.06 to 0.5 wt % of non-polymer catechins and an artificial sweetener. The content weight ratio (A)/(B) of (A) non-epicatechins to (B) epicatechins is from 0.54 to 9.0. This beverage is a highly clear packaged tea beverage, which contains catechins at a high concentration, makes the deterioration of catechins suppressed, is suited for long-term drinking, hardly changes in external appearance even during storage at a high temperature, and allows catechins to remain stable over a long term even when filled and stored in a clear package.

### FIELD OF THE INVENTION

This invention relates to a packaged tea beverage having the deterioration of catechins suppressed even when stored at a high temperature over a prolonged period in a transparent package.

### BACKGROUND OF THE INVENTION

Catechins are known to have a suppressing effect on the increase of cholesterol and an inhibitory effect on α-amylase activity (JP-A-60-156614 and JP-A-3-133928). However, it is necessary that an adult drink 4 to 5 cups of tea per day, in order to acquire such physiological effects. Thus there has been a demand for developing a technique devised to incorporate a high concentration of catechins in a beverage so that a large amount of catechins can be consumed with ease. One of such techniques is a method devised to incorporate catechins in a dissolved form into a beverage by using a concentrate of green tea extract (JP-A-2002-142677, JP-A-8-298930, and JP-A-8-109178) or the like. In this case, though, there is a problem that when a commercially-available green tea extract is used as it is, its catechin content tend to decompose during storage at a high temperature and it is therefore not suited for daily consumption over a long-term (e.g. long-term drinking) which is required to materialize the physiological effects of catechins.

### SUMMARY OF THE INVENTION

The present invention provides a packaged tea beverage having from 0.06 to 0.5 wt % of non-polymer catechins and an artificial sweetener, wherein the content weight ratio (A)/(B) of (A) non-epicatechins to (B) epicatechins is from 0.54 to 9.0.

### DETAILED DESCRIPTION OF THE INVENTION

The present invention provides a high-clarity, packaged tea beverage, which contains catechins at a high concentration, inhibits catechins from decomposing, is suited for long-term drinking, hardly changes in external appearance even during storage at a high temperature, and allows catechins to remain stable over a prolonged period even when filled and stored in a highly clear package.

The present inventors conducted an investigation for a packaged tea beverage which contains catechins at a high concentration and is suited for continued drinking over a prolonged period. As a result, it has been found that an addition of an artificial sweetener to a tea extract coupled with adjustments to the contents of non-epicatechins and epicatechins makes it possible to obtain a highly clear packaged tea beverage containing non-polymer catechins at a high concentration, which, contrasted with an addition of a natural sweetener such as sucrose, makes the decomposition of catechins suppressed and is suited for long-term drinking, hardly changes in external appearance even when stored at a high temperature, and allows catechins to remain stable over a prolonged period even when filled and stored in a clear package.

Alongside its aspect of containing non-polymer catechins at a high concentration, the packaged tea beverage of the present invention makes the decomposition of catechins suppressed, is suited for long-term drinking, hardly changes in external appearance even during storage at a high temperature, and allows catechins to remain stable over a long term even when filled and stored in a clear package.

The term “non-polymer catechins” as used herein is a generic term, which collectively encompasses non-epicatechins such as catechin, gallocatechin, catechingallate and gallocatechingallate, and epicatechins such as epicatechin, epigallocatechin, epicatechingallate and epigallocatechingallate.

The tea extract useful in the present invention can be obtained from tea leaves prepared from raw tea leaves available from the Genus Camellia, for example, C. sinensis, C. assamica, the Yabukita variety, or a hybrid thereof. When the prepared tea leaves is unfermented green tea, prepared tea leaves other than kamairicha (roasted tea), for example, ordinary sencha (middle-grade green tea), fukamushicha (deep-steamed green tea), gyokuro (shaded green tea), kabusecha (partially shaded green tea), tamaryokucha (steamed, rounded, beads-shaped green tea) or bancha (coarse green tea) is preferred. In the case of semi-fermented tea, tekkannon (Tieguangin), irotane, ougonkei (Huangjigui) or buigancha (Wuyiyaucha), which is generally called oolong tea, can be mentioned. In the case of fermented tea, black tea can be mentioned. As the tea extract, a green tea extract or oolong tea extract is preferred.

The tea extract useful in the present invention can be extracted and produced with water from tea leaves under general tea extraction conditions. The temperature of the water upon extraction from the tea leaves may be preferably from 70 to 100 (boiling water)° C., more preferably from 80 to 100 (boiling water)° C. from the viewpoint of improving the extraction efficiency of non-polymer catechins. The amount of the water upon extraction from the tea leaves may be preferably from 5 to 60 times, more preferably from 5 to 40 times as much as the weight of the tea leaves. The extraction time from the tea leaves may be preferably from 1 to 60 minutes, more preferably from 1 to 40 minutes, even more preferably from 1 to 30 minutes. An unduly short extraction time results in insufficient elution of non-polymer catechins, while an excessively long extraction time leads to a progress of an isomerization reaction of non-polymer catechins through thermal denaturation. An excessively low concentration of non-polymer catechins in a tea extract produced as described above requires the addition of the tea extract in a greater amount to the beverage. An excessively high concentration, on the other hand, results in the exclusion of trace components and the like, such as amino acids other than total polyphenol contained in the tea extract, which serve to improve the flavor. Such an excessively low or high concentration is, therefore, not preferred.

As an extraction solvent for tea leaves, an organic solvent such as ethanol may also be used in combination with water as needed. Upon extraction from tea leaves, an organic acid or a salt thereof such as sodium ascorbate may be allowed to coexist, for example, it maybe dissolved in extraction water beforehand. It is also possible to make combined use of boiling deaeration or an extraction method which is conducted while bubbling an inert gas such as nitrogen gas to eliminate dissolved oxygen, that is, under a so-called non-oxidizing atmosphere.

As the tea extract for use in the present invention, the above-described tea extract may be used after adjusting the solid content of non-polymer catechins to from 20 to 90 wt %, preferably from 25 to 40 wt % by purifying or concentrating the tea extract as needed, or a concentrate of a green tea extract may be used. As the concentrate of the green tea extract, one prepared by the process exemplified in detail, for example, in JP-A-59-219384, JP-A-4-20589, JP-A-5-260907, JP-A-5-306279, JP-A-2003-304811, JP-A-2003-219800 or the like can be mentioned. As a commercial product prepared by concentrating a green tea extract, “POLYPHENONTM” (product of Mitsui Norin Co., Ltd.), “TEAFURANTM” (product of ITO EN, LTD.), “SUNPHENON™” (product of Taiyo Kagaku Co., Ltd.) or the like can be mentioned. Further, a column-purified product or a chemical synthesis product can also be used. These catechin preparations generally contain from 25 to 40 wt % of non-polymer catechins. As the forms of such tea extract concentrates, various forms such as solids, aqueous solutions and slurries can be mentioned.

In tea leaves, non-polymer catechins mostly exist as epi-stereomers. By treatment under heat or with an acid or alkali, such epi-stereomers change into non-epi-stereomers as stereoisomers. The beverage according to the present invention requires that the content weight ratio (A)/(B) of non-epicatechins (A) to epicatechins (B) in the non-polymer catechins is from 0.54 to 9.0. Adjustments to the contents of the non-epicatechins and epicatechins can be achieved by forming a tea extract or a concentrate of a tea extract into an aqueous solution and then subjecting the aqueous solution to heat treatment, for example, at from 40 to 140° C. for from 0.1 minute to 120 hours. The pH of the solution may preferably be 4.5 or higher for the readiness of forming non-epicatechins. As an alternative, concentrates of tea extracts, said concentrates being high in the content of non-epicatechins, can be used. They can be used either singly or in combination.

In the packaged tea beverage according to the present invention, the content weight ratio (A)/(B) of the non-epicatechins (A) to the epicatechins (B) in the non-polymer catechins in the state dissolved in water is from 0.54 to 9.0. However, the content weight ratio may be preferably from 0.67 to 5.67, more preferably from 0.80 to 5.67. The content weight ratio in this range is preferred because, even when stored for a long time, the color tone is stable, the clarity in external appearance is maintained, and the flavor and taste are not impaired.

It is preferred to contain the non-epicatechins preferably at from 160 to 2,250 mg, more preferably at from 160 to 1,880 mg per 500 mL of the beverage. This content is preferred because, even when stored for a long time, the color tone is stable, the clarity in external appearance is maintained, and the flavor and taste are not impaired.

The content of gallates, which means the content of non-polymer catechin gallates as a generic term collectively encompassing catechingallate, gallocatechingallate, epicatechingallate and epigallocatechingallate in the non-polymer catechins, may preferably be from 35 to 95 wt %, more preferably from 35 to 98 wt %, even more preferably from 35 to 100 wt % from the standpoint of the effectiveness of the physiological effects of the non-polymer catechins.

It is preferred to use the tea extract after purification. Illustrative purification methods include (1) suspending the tea extract in water or a liquid mixture of water and an organic solvent such as ethanol, adding an organic solvent such as ethanol to the suspension, removing the resultant precipitate, and then distilling off the organic solvent; (2) dissolving the tea extract in an organic solvent such as ethanol, adding to the solution water or a liquid mixture of water and an organic solvent such as ethanol, removing the resultant precipitate, and then distilling off the organic solvent; and (3) dissolving the tea extract in water, cooling the solution to 5° C. or lower to cause creaming down, and then, removing the roiled sediment. As an alternative, it is also possible to use the tea extract after purifying it by supercritical extraction or after adsorbing it on an adsorbent resin and conducting elution with an ethanol solution or the like. A more preferred purification method includes dissolving a tea extract, which contains in a solid content thereof from 20 to 90 wt % of non-polymer catechins, in a 9/1 to 1/9 (by weight ratio) liquid mixture of an organic solvent and water, bringing the solution into contact with activated carbon and/or acid clay or activated clay, and then removing the organic solvent, the activated carbon and the like. By such purification, the content of caffeine can be lowered relative to the non-polymer catechins.

The content weight ratio of non-polymer catechins to caffeine (non-polymer catechins/caffeine) in the tea extract for use in the present invention may be preferably from 5 to 10,000, more preferably from 25 to 4,000, even more preferably from 35 to 1,000. The content weight ratio smaller than 5 leads to the abundant inclusion of components other than non-polymer catechins in a beverage, thereby undesirably impairing the inherent flavor, taste and external appearance of the beverage. The content weight ratio greater than 10,000, on the other hand, results in the exclusion of astringency suppressing components, which have been derived from tea leaves, at the same time as the removal of caffeine. This is not preferred from the standpoint of balanced flavor and taste.

The packaged tea beverage according to the present invention contains from 0.06 to 0.5 wt % of non-polymer catechins which are in a state dissolved in water. The content of non-polymer catechins may be preferably from 0.07 to 0.5 wt %, more preferably from 0.092 to 0.4 wt %, even more preferably from 0.11 to 0.3 wt %, even more preferably from 0.12 to 0.3 wt %. A content of non-polymer catechins within this range permits easy uptake of a great deal of non-polymer catechins, produces substantially no severe bitterness, astringency or puckeriness, and is also preferred from the standpoint of the colortone shortly after the preparation of a beverage.

The packaged tea beverage according to the present invention contains an artificial sweetener. From the standpoint of the deterioration-inhibiting effect for non-polymer catechins during storage over a long term, it is preferred to contain the artificial sweetener at from 0.0001 to 10 wt %, preferably from 0.001 to 10 wt %, more preferably from 0.01 to 10 wt %. With a natural sweetener such as sucrose, such deterioration-inhibiting effect for non-polymer catechins cannot be brought about.

Example of the artificial sweetener include high-sweetness sweeteners such as saccharin, saccharin sodium, aspartame, acesulfame-K, sucralose and neotame; and sugar alcohols such as sorbitol, erythritol and xylitol. As artificial sweeteners, sucralose, aspartame, erythritol, stevia, thaumatin, neotame, neohesperidin and dihydrochalcone are preferred, with sucralose and erythritol being more preferred. As commercial products, “SLIM-UP SUGAR™” (product of AJINOMOTO CO., INC.) composed of aspartame, “LAKANTO-S™” (product of SARAYA CO., LTD.) containing erythritol, and “PALSWEET™” (product of AJINOMOTO CO., INC.) composed of erythritol and aspartame can be used.

The pH of the beverage is preferably from 4.0 to 7.0, more preferably from 4.5 to 7.0, even more preferably from 4.5 to 6.5 from the standpoint of maintaining the natural flavor and taste. A pH lower than 4.0 may provide the beverage with a stronger sour taste and pungent smell, while a pH higher than 7.0 leads to a failure in achieving a harmony in flavor and also to a reduction in taste. pHs outside the above range are, therefore, not preferred.

The addition of a bitterness suppressor to the packaged tea beverage according to the present invention facilitates its drinking, and therefore, is preferred. Although no particular limitation is imposed on the bitterness suppressor to be used, a cyclodextrin is preferred. As the cyclodextrin, an α-, β- or γ-cyclodextrin or a branched α-, β -or γ-cyclodextrin can be used. In the beverage, a cyclodextrin may be contained preferably at from 0.01 to 0.5 wt %, more preferably at from 0.01 to 0.3 wt %.

To the packaged tea beverage according to the present invention, it is possible to add, as ingredients which may be added depending upon the formulation, additives such as antioxidants, flavorings, various esters, organic acids, organic acid salts, inorganic acids, inorganic acid salts, inorganic salts, colors, emulsifiers, preservatives, seasoning agents, sweeteners other than artificial sweeteners, sour seasonings, gums, emulsifiers, oils, vitamins, amino acids, fruit juices, fruit extracts, vegetable extracts, flower honey extracts, pH regulators and quality stabilizers, either singly or in combination.

It is possible to add, for example, one or more of flavorings and fruit juices to the packaged tea beverage according to the present invention with a view to improving the taste. Natural or synthetic flavorings and fruit juices can be used in the present invention. They can be selected from fruit juices, fruit flavors, plant flavors, and mixtures thereof. For example, a combination of a fruit juice with a tea flavor, preferably a green tea or black tea flavor has an attractive taste. Preferred fruit juices include apple, pear, lemon, lime, mandarin, grapefruit, cranberry, orange, strawberry, grape, kiwi, pineapple, passion fruit, mango, guava, raspberry, and cherry juices. More preferred are citrus juices (preferably, grapefruit, orange, lemon, lime and mandarin juices), mango juice, passion fruit juice, guava juice, and mixtures thereof. Preferred natural flavors include jasmine, chamomile, rose, peppermint, Crataegus cuneata, chrysanthemum, water caltrop, sugarcane, bracket fungus of the genus Fomes (Fomes japonicus) bamboo shoot, and the like. Such a juice can be contained preferably at from 0.001 to 20 wt %, more preferably at from 0.002 to 10 wt % in the packaged tea beverage according to the present invention. These concentrations are based on the single-strength beverage. Fruit flavors, plant flavors, tea flavors and mixtures thereof can also be used as flavorings. Even more preferred flavorings are citrus flavors including orange flavor, lemon flavor, lime flavor and grapefruit flavor. In addition to such citrus flavors, various other fruit flavors such as apple flavor, grape flavor, raspberry flavor, cranberry flavor, cherry flavor and pineapple flavor are also usable. These flavorings can be derived from natural sources such as fruit juices and balms, or can be synthesized. The term “flavoring” as used herein can also include blends of various flavors, for example, a blend of lemon and lime flavors and blends of citrus flavors and selected spices (typically, cola soft drink flavors). Such a flavoring can be added preferably at from 0.0001 to 5 wt %, more preferably at from 0.001 to 3 wt % to the packaged tea beverage according to the present invention.

Examples of the sour seasonings include, in addition to fruit juices and the like extracted from natural sources, citric acid, tartaric acid, malic acid, lactic acid, fumaric acid, and phosphoric acid. The sour seasoning may be contained at from 0.01 to 0.5 wt %, preferably from 0.01 to 0.3 wt % in the beverage.

Examples of the inorganic acids and inorganic acid salts include phosphoric acid, disodium phosphate, sodium metaphosphate, and sodium polyphosphate. The inorganic acid or inorganic acid salt maybe contained at from 0.01 to 0.5 wt %, preferably from 0.01 to 0.3 wt % in the beverage.

As a package suitable for use in the packaged tea beverage according to the present invention, a package of a conventional form, such as a molded package made of polyethylene terephthalateas a principal component (a so-called PET bottle), a metal can, a paper package combined with metal foils or plastic films, a bottle or the like, can be mentioned as in general beverages. The term “packaged tea beverage” as used herein means one that can be taken without dilution.

The packaged tea beverage according to the present invention can be produced, for example, by filling the beverage in a package such as a metal can and, when heat sterilization is feasible, conducting heat sterilization under sterilization conditions as prescribed in the Food Sanitation Act (Japan). For those which cannot be subjected to retort sterilization like PET bottles or paper packages, a process is adopted such that the beverage is sterilized beforehand at a high temperature for a short time under similar sterilization conditions as those described above, for example, by a plate-type heat exchanger or the like, is cooled to a particular temperature, and is then filled in a package. Under aseptic conditions, additional ingredients may be added to and filled in a beverage-filled package. It is also possible to conduct an operation such that subsequent to heat sterilization under acidic conditions, the pH of the beverage is caused to rise back to neutral under aseptic conditions or that subsequent to heat sterilization under neutral conditions, the pH of the beverage is caused to drop back to the acidic side under aseptic conditions.

The following examples further describe and demonstrate embodiments of the present invention. The examples are given solely for the purpose of illustration and are not to be construed as limitations of the present invention.

### EXAMPLE

### (Measuring Method for Catechins and Caffeine)

A high-performance liquid chromatograph (model: “SCL-10AVP”, trade name) manufactured by Shimadzu Corporation was used. The chromatograph was fitted with a liquid chromatograph column packed with octadecyl-introduced silica gel, “L-Column, TM ODS”, trade name (4.6 mm in diameter×250 mm in length; product of Chemicals Evaluation and Research Institute, Japan). A sample was filtered through a filter (0.8 μm), diluted with distilled water, and then subjected to chromatography at a column temperature of 35° C. by the gradient elution method. A solution containing acetic acid at 0.1 mol/L in distilled water was used as a mobile phase (solution A), while a solution containing acetic acid at 0.1 mol/L in acetonitrile was used as another mobile phase (solution B). Measurements were conducted under the conditions of 20 μL sample injection volume and 280 nm UV detector wavelength (Concentrations of catechins and caffeine are generally expressed in terms of weight/volume % (% [w/v]). In the Example, however, the contents of catechins and caffeine were each indicated in terms of a weight by multiplying the weight/volume % with the volume of the solution).

### (Measurement of Brix Degree)

A saccharimeter (model: “RX-5000”, trade name) manufactured by ATAGO CO., LTD. was used. With respect to each beverage, 1 to 2 droplets of the beverage were placed in a cell by a syringe, and the Brix degree of the beverage was measured at 20° C.

### (Measurement of Turbidity)

A haze/transmittance meter (model: “HR-100”, trade name) manufactured by MURAKAMI COLOR RESEARCH LABORATORY CO., LTD. was used. With respect to each beverage, the beverage was placed in a glass cell (light path length: 10 mm, width: 35 mm, height: 40 mm), and one (1) minute later, its turbidity was measured at 25° C.

### Example 1

Green tea leaves (the Genus Camellia, 0.8 weight parts), sodium ascorbate (0.0642 weight parts) and water (93.539 weight parts) were placed in an extraction tank, and were extracted at 65° C. for 7 minutes while stirring at 250 r/min from the 0^{th} to 35^{th} seconds and at 250 r/min from the 120^{th} to 130^{th} seconds. Subsequently, a green tea extract (2,812.7 weight parts) was obtained by filtration.

Using the thus-obtained green tea extract, beverages of the below-described compositions were prepared. The beverages were separately filled in PET bottles, and were then subjected high-temperature and short-time sterilization at 138° C. for seconds to produce packaged tea beverages.

### Beverage Compositions:

| | |
|---|---|
| Green tea extract | 0.80 wt % |
| Green tea extract preparation | 0.59 |
| Artificial sweetener or sweetener | (Table 1) |
| Sodium ascorbate | 0.0642 |
| Sodium hydrogencarbonate | 0.00722 |
| Purified water | Sufficient to give 100 in total |

TABLE 1

| | Example product 1 | | | Example product 2 | | | Comparative product | | |
|---|---|---|---|---|---|---|---|---|---|
| Sample | Std. | (a) | (b) | Std. | (a) | (b) | Std. | (a) | (b) |
| Sucralose | 0.04 | 0.04 | 0.04 | — | — | — | — | — | — |
| Erythritol | — | — | — | 10 | 10 | 10 | — | — | — |
| Granulated sugar | — | — | — | — | — | — | 10 | 10 | 10 |
| pH | 6.21 | 5.77 | 5.79 | 6.22 | 5.82 | 5.81 | 6.17 | 5.76 | 5.74 |
| Brix degree | 0.81 | 0.83 | 0.82 | 9.79 | 9.83 | 9.85 | 10.76 | 10.79 | 10.79 |
| Turbidity | 0.031 | 0.035 | 0.038 | 0.028 | 0.034 | 0.036 | 0.036 | 0.038 | 0.041 |
| Non-polymer catechins¹⁾ | 178.9 | 170.1 | 169.6 | 187.4 | 174.3 | 172.9 | 187.7 | 173.8 | 173.9 |
| Content of non-epicatechins²⁾ | 47.5 | 54.4 | 53.1 | 46.4 | 54.6 | 53.5 | 45.8 | 54.8 | 53.3 |
| Content of gallates²⁾ | 51.3 | 49.7 | 49.6 | 51.4 | 49.7 | 49.6 | 51.4 | 49.7 | 49.7 |
| Non-polymer catechins/caffeine | 7.02 | 6.62 | 6.63 | 7.05 | 6.58 | 6.57 | 7.03 | 6.46 | 6.51 |
| content ratio | | | | | | | | | |
| Percent residue of non-polymer | 100.0 | 94.2 | 94.2 | 100.0 | 93.5 | 93.3 | 100.0 | 92.1 | 92.7 |
| catechins²⁾ | | | | | | | | | |

¹⁾Unit: mg/100 mL
²⁾Unit: wt %

Concerning each of the packaged tea beverages filled with the beverages of the above-described compositions, the standard sample was stored for 2 weeks in an incubator controlled at 5° C., the sample (a) was stored for 1 week in a hot warmer (“YOSHIKIN CAN WARMER HW-168K”, trade name; rated voltage: 100 V, rated power consumption: 660 W), and the sample (b) was stored for 2 weeks in an incubator controlled at 55° C. Assuming that the content of non-polymer catechins in the standard sample was 100.0, the percent residue of non-polymer catechins in each of the samples (a) and (b) was then measured.

As shown in Table 1, the percent residue of non-polymer catechins in each of the example products 1 and 2 was superior to that in the comparative product. Further, the packaged tea beverages of the example products 1 and 2 both remained unchanged and clear in external appearance after storage.

1. A packaged tea beverage comprising from 0.06 to 0.5 wt % of non-polymer catechins and an artificial sweetener, wherein the content weight ratio (A)/(B) of (A) non-epicatechins to (B) epicatechins is from 0.54 to 9.0.

2. The packaged tea beverage according to claim 1, wherein the packaged tea beverage further comprises a tea extract.

3. The packaged tea beverage according to claim 2, wherein the tea extract is selected from the group consisting of a green tea extract, an oolong tea extract, or mixtures thereof.

4. The packaged tea beverage according to any one of claims 1-3, wherein the packaged tea beverage has a pH of from 4.0 to 7.0.

5. The packaged tea beverage according to any one of claims 1-4, wherein the artificial sweetener is sucralose or erythritol.

6. The packaged tea beverage according to any one of claims 1-5, wherein the packaged tea beverage is a packaged green tea beverage.
